(19) United States
(12) Patent Application Publication
(10) Pub. No.: US 2024/0283781 A1
(43) Pub. Date: Aug. 22, 2024

(54) System and Methods for Providing Anonymous Verified Identify and Session Management

(71) Applicant: Baaj Group LLC, Philadelphia, PA (US)

(72) Inventors: Tarvinder Sembhi, Philadelphia, PA (US); Jeff Behrbaum, Reston, VA (US)

(73) Assignee: Baaj Group LLC, Philadelphia, PA (US)

(21) Appl. No.: 18/430,087

(22) Filed: Feb. 1, 2024

Related U.S. Application Data
(60) Provisional application No. 63/446,947, filed on Feb. 20, 2023.

(51) Int. Cl. H04L 9/40

(52) U.S. Cl. CPC H04L 63/08

(57) ABSTRACT

Systems, methods, and apparatuses for enabling each of the three primary stakeholders in the identity and access management ecosystem (consumers, relying parties, and authoritative sources) to interact efficiently and securely to provide a consumer with access to desired systems, devices, applications, and services. In some example uses, this may provide a consumer with portability of their authenticated identity across multiple environments.

### CROSS REFERENCE TO RELATED APPLICATION

This application claims the benefit of U.S. Provisional Application No. 63/446,947, filed Feb. 20, 2023, entitled “System and Methods for Providing Anonymous Verified Identify and Session Management”, the disclosure of which is incorporated, in its entirety (including the Appendix) by this reference.

### BACKGROUND

Identity management, also known as identity and access management, is a framework of policies and technologies to ensure that only authorized users are able to access technology or other resources. Identity and access management systems typically operate to identify, authenticate, and control individuals' access to systems, devices, applications, and services. Identity management systems and processes address the need to ensure that only the appropriate users are able to access resources across an increasingly heterogeneous technology environment, while satisfying increasingly rigorous compliance requirements.

In general, identity and access management may include processes such as how users gain an identity (i.e., identity proofing and credential issuance), the roles and the permissions that an identity grants, the protection of that identity from being misused, and the technologies used in providing that protection (e.g., network protocols, digital certificates, and passwords, as examples).

For example, an identity management system operates to check a login attempt against an identity database, which is an ongoing record of everyone who should have access to a specific system, device, application, or service. This information is updated (at least in theory) as people join or leave an organization, their roles and projects change, and the organization's scope evolves. Examples of the information stored in an identity management database include employee names, job titles, managers, direct reports, mobile phone numbers, and personal email addresses. Matching someone's login information (such as their username and password) with their identity in the database is referred to as an authentication process. Increasingly, information stored or linked to the identities in the identity databases includes information that extends beyond the traditional identity information. This additional information can include biometrics, behavioural information, or personas, among other forms or types of information.

For added (or more reliable) security, many organizations require a user to verify their identity with a form of multifactor authentication (MFA). Also known as two-way (channel) verification or two-factor authentication (2FA), MFA is more secure than using only a username and password. MFA adds a step to the login process where the user must verify their identity with an alternate verification method. The alternate verification methods can include mobile phone numbers and personal email addresses. The identity and access management system typically sends a one-time code to the alternate verification method, which the user must enter in the login portal within a set time period to continue the login process.

Access management is the second primary function of such identity management systems. After the system has verified that the person, process, or device attempting to access a resource matches their authenticated identity, access management keeps track of which resources the person or thing has permission to access. This is often a dynamic process, as organizations typically grant varying levels of access to resources and data, where the levels are determined by factors such job title, tenure, security clearance, and project. The process of granting the correct level of access after a user's identity is authenticated is referred to as authorization. A primary goal of identify and access management systems is to ensure that authentication and authorization happen correctly and securely for every access attempt.

Establishing an identity is typically done through an Identity Proofing process. This process typically entails verifying an individual's identity claims using one or more authoritative sources to verify that a person is who they say they are. An example is enrolling an individual in a website that offers age restricted goods or services. In this situation, a website might provide authentication by taking the identity claim of the individual, and then scanning a driver's license and/or checking against other systems to ensure the individual is over the age restriction or threshold. Once the identity information claimed by the individual is verified, they can be enrolled in a system and issued a credential. The credential could be a username, an ID card, a verifiable credential, a token, or another method that ties the individual to the identity.

However, the more recent interest and popularity of environments and activities such as gaming, augmented reality, virtual reality, and other Web 3.0 implementations make current approaches to identity and access management insufficient. This at least in part because the identity ecosystem has three major stakeholders (typically referred to as consumers, relying parties, and authoritative sources). Thus far, current approaches have largely focused on addressing the needs of either the consumer or the relying party. As a result, the approaches have not addressed the full set of needs across the entire ecosystem and as a result, have not been widely adopted. Identity security and management is a multiple stakeholder system and current approaches address only one or two of the stakeholders—this creates a reluctance for the other party or parties to participate due to inefficiencies that are created for those other stakeholders.

Furthermore, privacy has become a major concern due to increased regulatory regimes and heightened consumer awareness around protecting personally identifiable information (PII). In addition, consumer adoption in these new environments is often predicated on anonymity where consumers provide identity information only when required, and usually for transaction or compliance purposes. Finally, the new environments rely on a frictionless user experience and require interoperability with respect to identity as consumers interact between one environment and another.

What is desired are systems, apparatuses, and methods for more efficiently and reliably enabling each of the stakeholders that are part of the identity and access ecosystem to interact while satisfying one or more regulatory, privacy, or security concerns. Embodiments of the disclosure address this and other objectives both individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the systems, apparatuses, and methods disclosed and/or described herein are directed to systems, methods, and apparatuses for enabling each of the three primary stakeholders in the identity and access management ecosystem (consumers, relying parties, and authoritative sources) to interact efficiently and securely to provide a consumer with access to desired systems, devices, applications, and services. In some example uses, this may provide a consumer with portability of their authenticated identity across multiple environments. The proposed system or platform addresses both the desire of consumers for anonymity and the identity verification and access control capabilities required by relying parties.

A system for use in implementing an embodiment of the disclosed identity management, access control, and session management functions or operations may include the following elements, components, services, or modules and associated steps, stages, functions, or operations:
A module, component, process, or service to generate and issue a verifiable credential to establish foundational identity and consumer control. In one embodiment, the verifiable credential will be based on the DID standard (a decentralized and globally unique identifier and its associated properties and functions) described in the W3C standards, as described in greater detail in the Appendix to this application;
   In one sense, such a foundational identity is represented by the first establishment of a DID. In most cases, it is verified through an Identity proofing process. However, one can create such an initial foundational identity anonymously with an associated attribute. The DID provides the foundational (initial) identity and once it is generated, additional attributes can be attached to the identity as they are verified. The DID standard is such that whoever is the holder of that identity (consumer) has control to access the identity information inside the DID;
An Identity as a Service (IDaaS) process, service, or capability to manage the verifiable credential and provide consumer control—this service will enable an enterprise to perform services and add value for the consumer by leveraging the verifiable credential using Web 2.0/3.0 protocols (as examples);
A Passive Register and Session Management module, process, or functionality that enables a seamless (and in many cases, behind the scenes) user experience for authenticating a user as they transfer from one environment to another (i.e., facilitating using an identity that has been authenticated in one environment in a different environment without undergoing a separate re-authentication process flow);
   The Passive Register and Session Management module or modules enable and implement a Passive Register that stores DID identity verification and/or attribute verification and other authentication metadata. The authentication and verification information are available in a session which can then be leveraged by multiple parties. The information is available via a consent mechanism that is tied to the DID holder, in accordance with W3C standards; and
One or more Identity Data Service(s) which may include a service that links scores, data, media, and/or other information to the verified credential (e.g., the created DID). As non-limiting examples, this may include a Reputation Score, an Intent Manager, or a Transactional Data Manager service.

The disclosed system may include a set of computer-executable instructions stored in (or on) one or more non-transitory computer-readable media and one or more electronic processor or co-processors. When executed by the processor or co-processors, the instructions cause the processor or co-processors (or an apparatus or device of which they are part) to perform a set of operations that implement an embodiment of the disclosed processes, functions, operations, or methods.

In one embodiment, the disclosure is directed to one or more non-transitory computer-readable media including a set of computer-executable instructions, wherein when the set of instructions are executed by an electronic processor or co-processors, the processor or co-processors (or an apparatus or device of which they are part) perform a set of operations that implement an embodiment of the disclosed processes, functions, operations, or methods.

In some embodiments, the systems, devices, and methods disclosed and/or described herein may provide services through a SaaS or multi-tenant platform. The platform provides access to multiple entities, each with a separate account and associated data storage. Each account may correspond to a user (e.g., a consumer or relying party), set of users, an entity, a set or category of entities, a set or category of users, or an organization, for example. Each account may access one or more services, a set of which are instantiated in their account, and which implement one or more of the methods, operations, or functions disclosed and/or described herein.

Other objects and advantages of the systems, apparatuses, and methods disclosed may be apparent to one of ordinary skill in the art upon review of the detailed description and the included figures. Throughout the drawings, identical reference characters and descriptions indicate similar, but not necessarily identical, elements. While the embodiments disclosed and/or described herein are susceptible to various modifications and alternative forms, specific embodiments are shown by way of example in the drawings and are described in detail herein. However, the disclosure is not limited to the exemplary or specific embodiments described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a diagram illustrating the primary functional modules, processes, operations, components, or elements in an implementation of an embodiment of the disclosed and/or described system and method;

FIG. 1(b) is a block diagram illustrating the integration of the primary functional modules, components, processes, or elements of FIG. 1(a) into a system, service, or platform;

FIG. 1(c) is a flowchart or flow diagram illustrating a non-limiting example of the data processing flow and operations that may be implemented by an embodiment of the disclosed and/or described system and methods;

FIG. 2(a) is a block diagram illustrating an initial authentication process into an environment for a user, in accordance with one or more embodiments of the disclosure;

FIG. 2(b) is a block diagram illustrating how the disclosed Passive Register and Session Manager (PRSM) and associated functionality can be implemented and used to provide seamless authentications to subsequent environments by leveraging the information stored in the PRSM, in accordance with an embodiment of the disclosure;

FIG. 3(a) is a diagram illustrating a non-limiting example of a set of elements, components, functions, operations, and processes for creating a score or other evaluation and linking the score to the DID, in accordance with an embodiment of the disclosure;

FIG. 3(b) is a diagram illustrating a non-limiting example of a set of elements, components, functions, operations, and processes for the capture of consumer intents and linking those intents to the DID, in accordance with an embodiment of the disclosure;

FIG. 4 is a diagram illustrating elements or components that may be present in a computing device, platform, or system configured to implement a method, process, function, or operation in accordance with some embodiments of the systems, apparatuses, and methods disclosed and/or described herein; and

FIGS. 5-7 are diagrams illustrating an architecture for a multi-tenant or SaaS platform that may be used in implementing an embodiment of the systems and methods disclosed and/or described herein.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure are described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among others, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by one or more suitable processing elements (such as a processor, co-processor, microprocessor, CPU, GPU, TPU, QPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user or processor through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, the systems, devices, and methods disclosed and/or described herein may provide services through a SaaS or multi-tenant platform. The platform provides access to multiple entities, each with a separate account and associated data storage. Each account may correspond to a user (e.g., a consumer or relying party), set of users, an entity, a set or category of entities, a set or category of users, or an organization, for example. Each account may access one or more services, a set of which are instantiated in their account, and which implement one or more of the methods, operations, or functions disclosed and/or described.

In some embodiments, one or more of the operations, functions, processes, or methods disclosed and/or described herein may be implemented by a specialized form of hardware, such as a programmable gate array or application specific integrated circuit (ASIC). Note that an embodiment of the disclosed/described methods may be implemented in the form of an application, a sub-routine that is part of a larger application, a “plug-in”, an extension to the functionality of a data processing system or platform, or other suitable form. The following detailed description is, therefore, not to be taken in a limiting sense.

The increase in use of remote transactions has accelerated the need for a lower friction, easy to utilize, secure, and reliable remote identity management service. In a typical scenario, the identity ecosystem triad is comprised of three stakeholders:
The user/consumer: the consumer is engaging in (or with) the digital ecosystem to access services, perform research, and/or to provide services. To engage, the consumer needs to provide identity information to the relying party to ensure they can onboard the consumer. In addition, the consumer trusts that each time they (re)engage with a system, the system identifies that it is the same consumer with minimal friction or burden on the consumer;
   A motivation is that the relying party wants to ensure that no other person has logged on (i.e., prevention of impersonation), while the consumer assumes that the login process has sufficient security/privacy built in but wants it to be a seamless experience to utilize. If the system can verify to the relying party that they are accepting only the unique person holding a verifiable credential, they are also serving to prevent fraud;
   For example, a consumer who wishes to open a new bank account remotely must provide proof of their identity to satisfy the bank's regulatory requirements for opening an account. However, if the process of providing a government issued identity becomes too burdensome, the consumer may abandon the application. Similarly, a consumer may visit a website for age restricted content. If the consumer only wishes to provide proof of their age without providing additional identity details for privacy concerns, then websites that incorporate a method to capture proof of age without the need for additional identity information will be preferable for consumer adoption;
The relying party: relying parties need to verify the claimed identities (i.e., the asserted identity of a user) for both remote onboarding and authentication of a user by a valid proof of an identity. In many industries, the relying parties must meet strict KYC (know your customer) compliance guidelines for onboarding an individual. In addition, recent data breaches and concerns regarding data protection are driving relying parties to implement systems that are intended to minimize data acquisition and storage, respect privacy, and secure sensitive information;
Authoritative Sources: much of the identity information is tied to (or associated with) an individual by issuing authorities. For example, the department of motor vehicles (DMV) issues a driver's license which contains an individual's picture and address. The address has been verified by the DMV, and by proxy, the driver's license can then be used to verify the address of the individual. In many cases, 3^{rd} parties provide identity services to verify that a claimed identity or specific information about an identity can be traced back to an authoritative (and presumably reliable) source.

In some embodiments, a robust identity management system and methods as disclosed and/or described herein serves as an intermediary between a consumer, a relying party, and an authoritative source. A robust identity management system provides identity services to a relying party by leveraging 3^{rd} parties and/or authoritative sources directly to verify an identity claim of a consumer. In a peer-to-peer system, parties may act as both consumer and relying party. As such, the system and methods disclosed and/or described herein can be use in traditional relying party-consumer systems as well as in peer-to-peer systems.

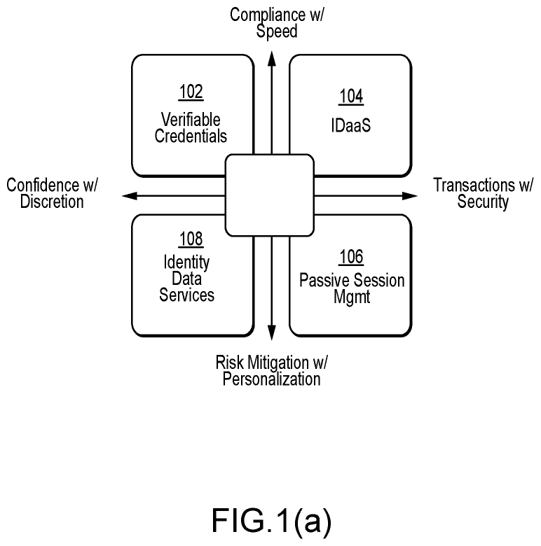

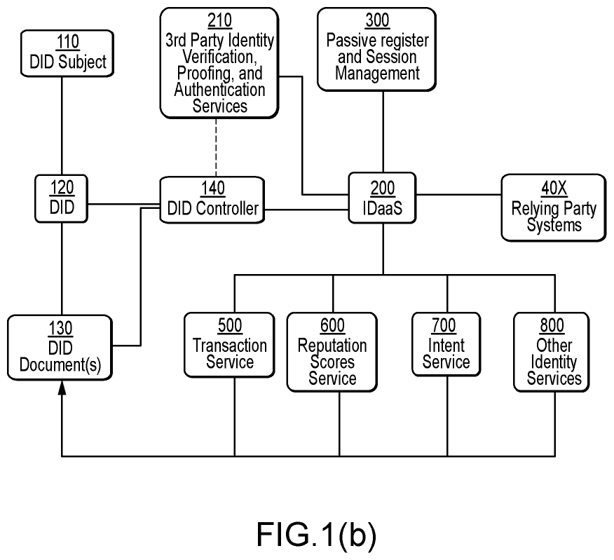

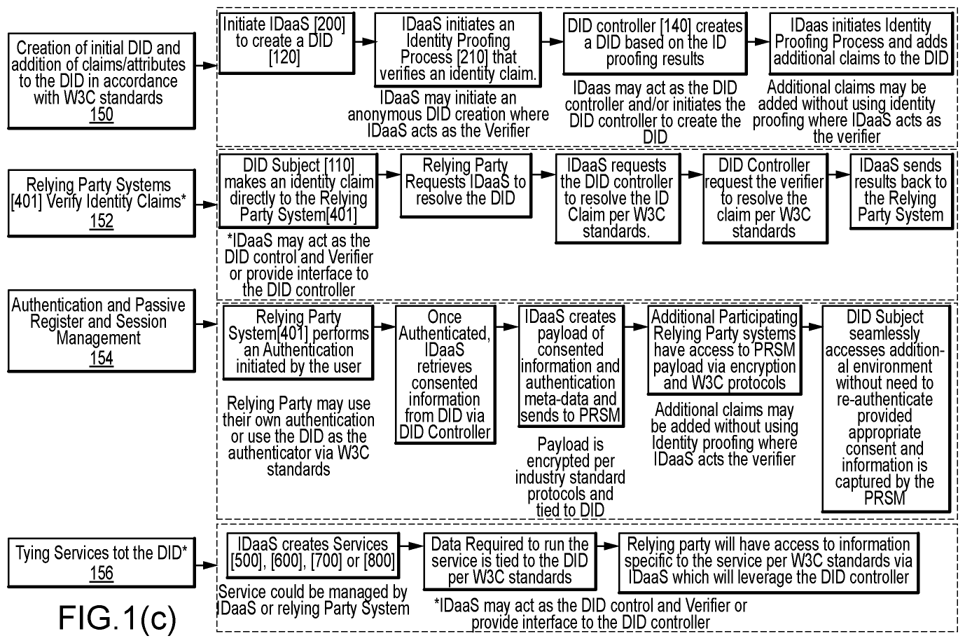

FIG. 1(a) is a diagram illustrating the primary functional modules, processes, operations, components, or elements in an implementation of an embodiment of the disclosed and/or described system and methods. As shown in the figure, in one embodiment, a system comprising these may include:
One or more modules, processes, operations, components, or elements operable to generate a verifiable credential (as suggested by element, component, or process 102);
One or more modules, processes, operations, components, or elements operable to provide Identity as a Service (IDaaS), and manage the verifiable credential to provide consumer/user control over its use and distribution (as suggested by element, component, or process 104);
One or more modules, processes, operations, components, or elements operable to provide passive session management to enable consumers/users to seamlessly authenticate in one environment and use that authentication for access to another environment (as suggested by element, component, or process 106); and
Identity Data Services—this platform or system service operates to link scores, data, media, and/or other information to the verified credential (as suggested by element, component, or process 108).

The Identity as a Service (IDaaS) modules, processes, operations, components, or elements provide a mechanism to manage the DIDs and enable relying parties to consume and use the DIDs more easily and reliably. In one embodiment, the IDaaS may include modules, processes, operations, components, or elements for performing the following:
a. Identity verification services via native (i.e., on platform) or 3^{rd} party services;
b. An ability to interface with or act as the DID controller: The IDaaS will provide the management of the DID, essentially providing the services as a DID controller. These services may include one or more of:
   i. An ability to manage the evolution (transition) of a DID from an anonymous ID to Verified attributes to a verified identity;
      1. Each such stage of the DID may involve additional verification or authentication processes, and provide additional benefits to a relying party;
   ii. An ability to verify assertions made by the DID subject as defined by the W3C (or other relevant standard); or
   iii. A consent mechanism that enables the DID subject (i.e., the user) to securely share information;
c. Authentication services per DID documents and/or other means;
   i. This may include authentication/verification of a user and/or verification of an attribute pertaining to the user by use of information accessible through the DID;
d. An interface with a Passive Register and Session Manager (PRSM) to enable a seamless ability to be authenticated when transferring from one environment to another; and
e. An interface with one or more Identity Data Service(s) This may include (as non-limiting examples) Reputation Score, (User) Intent Manager, or a Transactional Data Manager, amongst other services that are connected to the DID or a DID transaction.

FIG. 1(b) is a block diagram illustrating the integration of the primary functional modules, components, processes, or elements of FIG. 1(a) into a system, service, or platform.

The following is a description of the system components for an example embodiment, as illustrated in FIG. 1(b):
a) The Verifiable Credential (W3C defined components for a DID):
   DID Subject [110]—the entity defined by or associated with the DID¹;
   DID [120]—the decentralized identifier as defined in the W3C standards;
   DID Documents [130]—these contain information associated with the DID;
      In one embodiment, the DID document is referred to by a URL that points to a document or set of data or information;
DID Controller [140]—the entity (typically a process, element, or component) that has the capability to make changes to the DID Documents;
Typically, the DID architecture has other components that are used to verify, authenticate, and modify information associated with the DID. An example architecture is provided in the Appendix and is outlined at: (https://www.w3.org/TR/did-core/) Decentralized Identifiers (DIDs) v1.0 (w3.org);
b) IDaaS [200]—this element, component, or process interfaces with the other elements, components, or processes of the system. The IDaaS may also perform functions or operations to enable it to act as the DID controller, ID Verification provider, or authenticator, although these components may be performed by elements, components, or processes separate from the IDaaS; ¹In addition to the Appendix, see one or more of the following sources for a description of the DID (a decentralized and globally unique identifier) and its associated properties and functions: https://www.w3.org/TR/did-core/, https://w3c-ccg.github.io/did-primer/.
   The IDaaS may interface with one or more 3^{rd} party identity, verification, proofing, or authentication services [210];
c) Passive Register and Session Manager [300]—this element, component, or process provides session management services to enable a consumer/user to seamlessly authenticate in one environment and use that authentication for access to another environment;
d) Identity Data Services (these are typically optional and one or more may interface with the IDaaS):
   Transaction Data Services [500]—associates an authentication request/event or other event(s) to the DID via the IDaaS;
   Reputation Score Service [600]—associates reputation scores to the DID;
   Intent Data Service [700]—associates consumer/user intent data to the DID;
      In one embodiment, user intent may be determined by information the user directly entered or from analytics obtained from a consumer transaction, profile, or other source of information;
   Other Data Services [800]—services that associate other forms or types of data to the DID;
   Relying Party System(s) [401]—the system(s) of an entity that wishes to identify the subject of the DID using the IDaaS.

Although FIG. 1(b) illustrates a set of services (e.g., 500, 600, 700, 800) that may generate and/or provide data to the IDaaS (200) for associating with the DID, these are non-limiting examples. Other types of services may similarly be used or accessed to provide additional information for inclusion in or association with a DID. Non-limiting examples of other types of services are notification services or monitoring services.

The Decentralized Identifier (DID) defined in the W3C standard provides a framework to create a verifiable credential which may be utilized in an embodiment of this disclosure. As disclosed and/or described herein, the DID architecture can be leveraged to provide anonymity and consumer/user control of the data associated with their DID. As a result, embodiments of the disclosure describe a methodology that can be used to enable consumers to remain anonymous, verify their information, and/or provide verified identity data to a relying party.

The DID or DID Documents (as defined in the W3C standards) do not store Personally Identifiable Information (PII). Per the W3C DID standards, the DID resolves to a DID Document that may be used for purposes of verification, authentication, and/or assertions with identity attributes associated with the DID. As a non-limiting example, the following process provides an illustration of how a DID can “evolve” from an anonymous identity to a verified attribute that is tied to a verified identity:
a. Anonymous DID creation: Using the W3C DID standards, non-identifying information (such an anonymous username) can be data that is associated with the DID subject. The DID subject's anonymous information can then be verified via the DID document using the W3C standards. In this manner, the anonymous information can be associated with the DID subject without the DID subject providing additional ID or personalized information;
b. Verified Attribute: A verified attribute is an attribute that has been verified by an “authoritative” source. In many cases, the authoritative source traces back to a government issuing agency (such as a motor vehicle department or social security office). Attribute verification can also be done by a 3^{rd} party that verifies against issuing and/or other authoritative sources and provides a verification result. An example of a verified attribute could be that a subject is “older than 21”. In this case, the “older than 21” attribute can be associated with the DID subject and can be verified per the W3C standards once that attribute has been verified by an authoritative source. In this way, relying parties that require age verification can verify that an individual is “older than 21” without the user/subject having to exchange personally identifiable information;
c. Verified Identity Data: Verified identity data such as name, phone number, or address can be associated with the DID. The verification of the data is done via an authoritative source similarly to a verified attribute, as described above. However, in this case the verified data is associated with the DID subject, again using the W3C standards. Subsequently, that identity data can be verified using the W3C protocols.

The identity data can be associated with the DID all at one time, one by one, or in a sequence the DID controller requires. In this way, a DID can “evolve” from an anonymous ID to an anonymous ID with verified attributes, and then to an anonymous ID with verified identity data. Using the W3C standards, the DID subject/user can remain anonymous while controlling with whom they share the identity data. Although in some embodiments, this disclosure is directed to using the DID as the foundation of a verifiable credential, other verifiable credentials (such as a copy of a driver's license stored on a mobile phone) can be used in addition (or instead).

FIG. 1(c) is a flowchart or flow diagram illustrating a non-limiting example of the data processing flow and operations that may be implemented by an embodiment of the disclosed and/or described system and methods. As shown in the figure, a first step or stage (150) in the data processing may comprise the creation of an initial DID for a user and the association of one or more claims or attributes with the DID, where the claims or attributes are associated with the DID in accordance with the W3C standards (or another applicable standard being utilized). As shown, this may include using the IDaaS to initiate a process to validate an initial identity claim, followed by the creation of a DID, and followed (if or when desired) by the addition of other claims or attributes to the DID.

Next, a relying party and its associated systems seek to verify an identity claim (as suggested by step or stage 152). In an example of this process flow, a subject (e.g., a subject, user, or consumer) makes an identity claim (such as their age, or an achievement) to the relying party's system(s). The relying party then requests the IDaaS to resolve or verify the claim based on the DID. The IDaaS requests that the DID controller resolve the claim in accordance with W3C standards (or another applicable standard being utilized). The DID controller requests a verifier function or operation to verify the claim asserted by the subject. The IDaaS receives the result of the verification process and relays it to the relying party.

The relying party authentication of the subject and session management using the passive register (as suggested by step or stage 154) then follows. In this step or stage, the relying party receives the data from the IDaaS and performs an authentication (typically after initiation by the subject/user). As indicated by the figure, the relying party may perform the authentication using their own process (which may include additional requirements or analysis beyond that performed by the DID) or use the results of the DID verification.

Once the subject and/or subject's claim(s) are authenticated, the IDaaS receives the information consented to be released or shared by the subject (i.e., the identity information and/or asserted claim) from the DID via the DID controller. The IDaaS creates a data payload containing the information and authentication process meta-data, and provides it to the PRSM element (typically, the payload is encrypted and associated with the DID). The systems of other participating relying parties have access to the payload using accepted session management, encryption, and/or W3C protocols. The subject/user is then able to seamlessly access a new environment (typically one associated with a different relying party) without needing to re-authenticate themselves, provided the information required by the new relying party is available through the payload.

As suggested by step or stage 156 in the figure, one or more services may be associated with or tied to the DID. The IDaaS may create or operate these services or may access them as part of generating additional information used to authenticate an identity, prove an asserted claim, or provide data or information for inclusion in a payload.

As mentioned, although FIG. 1(b) illustrates a set of services (e.g., 500, 600, 700, 800) that may generate and/or provide data to the IDaaS (200) for associating with the DID, these are non-limiting examples. Other types of services may similarly be used or accessed to provide additional information for inclusion in (or association with) a DID. Such services may be managed by the IDaaS and/or a relying party system (such as for purposes of performing an industry specific evaluation or “scoring” of a subject).

Data or information for a specific service may be tied to or associated with the DID, typically in accordance with W3C standards. A relying party may access the data or information for a service via the IDaaS (which may utilize the DID controller) and in accordance with applicable W3C standards.

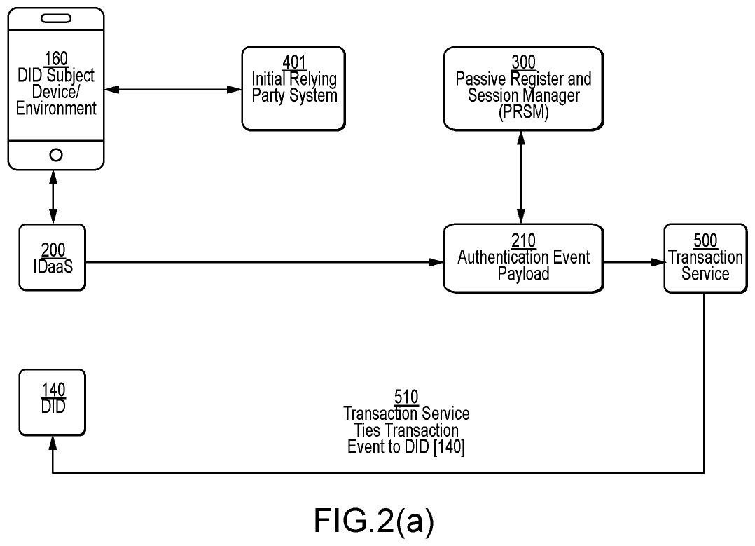

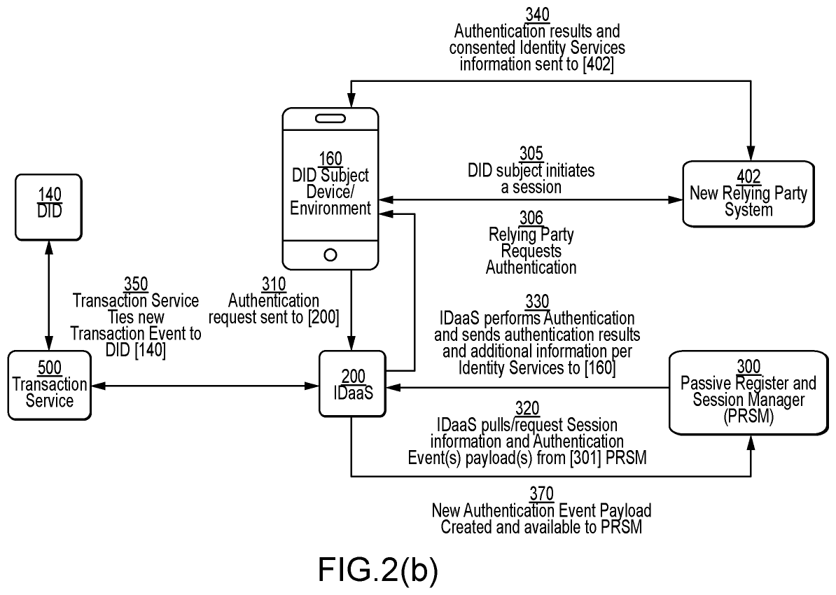

FIG. 2(a) is a block diagram illustrating an initial authentication process into an environment for a user, in accordance with one or more embodiments of the disclosure. As a non-limiting example, a subject/user lands on a log-in webpage of a relying party and initiates the relevant log-in protocol to gain access to the relying party's website. In response, the relying party initiates an authentication check using its preferred methods (represented by system [401] and based on the W3C standards using the DID if it chooses to use that approach).

Once the subject is initially authenticated, the relying party system [401] initiates a request to the DID Device/Environment [160] to obtain the identity information from the DID using W3C standards. The relying party may also send a payload with the system [401] authentication metadata along with the DID information request. The DID Subject Device/Environment [160] forwards the request and payload to the IDaaS [200] where the IDaaS resolves the DID for the identity information requested and consented to (for release) by the subject.

The IDaaS then creates a payload that contains the authentication metadata plus information from the DID resolution process [210]. The payload is secured and/or tokenized using industry standard encryption/security protocols. The payload is sent to the Passive Register and Session Management element, component, or process [300], where the tokenized authentication payload is tied to (associated with) a session. The metadata of the transaction may also be recorded and tied [510] to the DID [140] using a transaction service [500].

FIG. 2(b) is a block diagram illustrating how the disclosed Passive Register and Session Manager (PRSM) (indicated as element, component, or process 300) and associated functionality can be implemented and used to provide seamless authentications to subsequent environments by leveraging the information stored in the PRSM, in accordance with an embodiment of the disclosure.

As disclosed, the PRSM enables a user to seamlessly transition from one environment to another with a verifiable (or verified) credential (and in some situations, with specific verified data or information), and may be used to store authentication, identity, and other session information temporarily. The PRSM's passive register can be accessed to manage transition from one digital environment to another via the IDaaS [200] interfaces. The other digital environment being accessed (and for which identity verification is provided or transported) may include, but is not limited to websites, digital accounts, virtual/augmented reality environments, or gaming experiences. The PRSM can be managed by the IDaaS component and thereby leverage the DID [140].

Note that a verifiable credential is a reusable digital credential that can be used for an anonymous identity, a verified identity, or an identity with a verified attribute. For example, a verified attribute can be a user handle such a Player1, where Player1 is issued to a certain user in a gaming platform without other identifying information. The holder of Player1 credential (the user it was issued to) can then present that credential to other players (and the gaming platform) who want to transact with Player1.

A verified credential can also be a verified identity such as a driver's license where an issuing authority verifies that that this is an identity verified by an authoritative source. A verified identity can contain verified attributes but maintain its anonymity. For example, the gaming platform may have verified Player1's age using third party services. The gaming platform then attaches the age to Player1's verifiable credential. As such, Player1 can then provide his credential to prove (establish) his/her age without the need to provide other personally identifiable information.

As mentioned, FIG. 2(b) is a representative process of how the PRSM [300] can be implemented and utilized to enable a user to authenticate their identity in one environment and then seamlessly transport that authenticated identity into a second environment. An illustrative processing flow that may be implemented by the PSRM is as follows (and is described with reference to FIGS. 2(a) and 2(b)):
A subject/user uses a device [160] to authenticate their identity with respect to a first environment for a relying party [401] using IDaaS [200] (as illustrated in FIG. 2(a));
A payload [210] from the initial authentication event is created by IDaaS [200] and stored on the PSRM [300] using industry standard session management practices. In one embodiment, the payload may contain information used to facilitate authentication for a second (new) relying party [402] (as illustrated in FIG. 2(b));
   As an option, the authentication transaction details maybe logged in a transaction service [500] which can then be associated with the DID [140] using the W3C standards;
   Using their device [160], the user initiates a session with a second environment (as suggested by step or stage [305] in FIG. 2(b)). The second environment (i.e., that associated with the second (new) relying party [402]) will typically request authentication using a standard industry protocol (as suggested by step or stage [306] in FIG. 2(b));
The device [160] subsequently sends the authentication request to the IDaaS [200] along with the payload [210] information (as suggested by step or stage [310] in FIG. 2(b));
The IDaaS [200] then verifies the payload information. In addition, if the relying party request [306] requires additional information, the IDaaS [200] will initiate a consent and authentication process per the relying party request (as suggested by step or stage [320] in FIG. 2(b)). The additional information could include (but is not limited to, or required to include) reputation scores, user/subject intent information, an additional authentication request, and/or other information tied to or associated with the DID [140]. IDaaS [200] will ensure consent from the user was received before returning results, where consent may be received directly or indirectly;
   In addition, IDaaS may add information to a session [370] that can be made available for subsequent transactions via the PRSM;
The authentication results will then be sent to the device [160] (as suggested by [330] in FIG. 2(b)). The device [160] then sends the results to the Relying Party system [402] (as suggested by step or stage [340] in FIG. 2(b)). The relying party will then provide the requested access per its processing and interpretation of the authentication results;
   As an option, IDaaS can log the transaction in a transaction service [500] and associate the transaction to the DID using W3C (or other acceptable) protocols.

FIGS. 2(a) and 2(b) illustrate an example method to tie authentication transactions to the DID using W3C standards. Via the IDaaS, the relying parties can tie (i.e., associate) transaction information to the DID. Transactions can further be categorized, labeled, or organized to indicate industry description, healthcare, or financial, as non-limiting examples. These categorized, labeled, or organized transactions can be used to provide additional information to relying parties relative to the transaction they are engaged in with the DID subject/user. As an example, a relying party which is provided access to transaction logs (via a consent mechanism, per W3C guidelines) will be better able to understand what industries the DID holder transacts with, at what time of year, or other aspects, and be able to provide relevant promotions, offers, and services to the user.

Embodiments of the disclosed and/or described system and methods also enable anonymous IDs to be authenticated and utilized to provide access to services, applications, and systems, as non-limiting examples. Reputation scores (or other form of evaluation) associated with a DID may provide additional information to a relying party to assist in deciding if they want to continue a transaction with the anonymous ID. As a non-limiting example, a reputation score may be generated or derived based on one or more of the following metrics:
Completeness of Identity data;
Historical transaction record(s) (such as prior authentications or actions);
Peer Reviews; or
Other metrics as available, or that are specific to a particular industry, use case, or environment (such as credit scores or indications of social network activities).

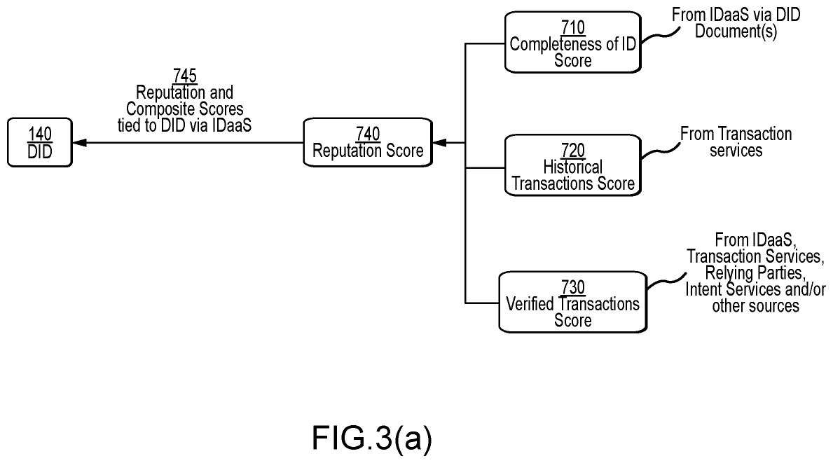

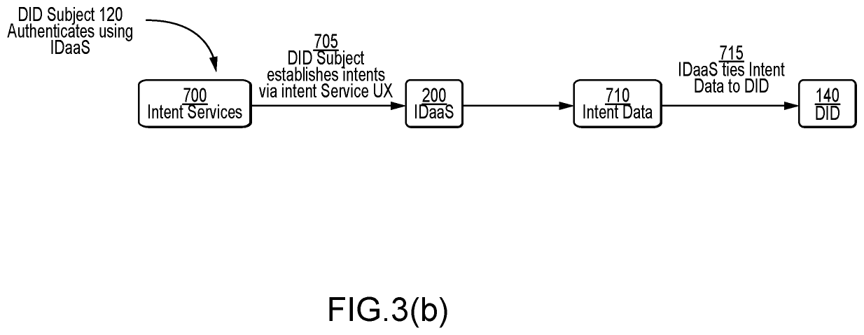

FIG. 3(a) is a diagram illustrating elements, components, functions, operations, and processes for an example of how a score or other form of evaluation may be created and then linked to the DID, in accordance with an embodiment of the disclosure. As suggested by the figure, in one embodiment, one or more services (illustrated as [710] (completeness of ID score), [720] (historical transaction score), and [730] (verified transaction score) in the figure) may be used to generate data which is used to generate a reputation score [740] which is then associated with a DID [140] by the IDaaS, as suggested by step or stage [745].

Note that although a set of services used to generate a reputation score are illustrated in FIG. 3(a), other types of services may be used and/or scores may be generated and associated with a DID by the IDaaS (such as 500, 600, 700, or 800 in FIG. 1(b), or other types or forms of services of interest to a relying party). As suggested by FIG. 3(a), in some embodiments, one or more individual components of a score may be determined by a service based on data or information in a DID or from another source (such as an intent service, relying party, or other source). The components may be combined to yield a desired score or evaluation metric (as suggested by reputation score [740]). The score or evaluation associated with the DID may be generated by a suitable process, including a ruleset, trained model, or defined set of mathematical or logical operations, as non-limiting examples.

At present (i.e., in conventional approaches), a consumer's information is collected, either by consent or surreptitiously, and the information is used for marketing purposes by relying parties, marketing companies, and advertising agencies to offer more personalized services and products to the consumer. However, this approach or model is problematic for at least the following reasons:
The information in many cases is obtained and/or stored without consumer consent. Further, in most cases it is used without consent;
Regulations regarding the use and exchange of consumer information are becoming more restrictive and privacy centric practices are being required;
Due to the regulations and the occurrence of data breaches, relying parties are minimizing personal identity databases to limit their potential liability; and
Consumers are increasingly demanding more and better privacy compliant techniques before being willing to share their information.

The disclosed and/or described IDaaS and other elements, components, functions, or processes provide a mechanism to “capture” the consumer “intent” (the consumer's desire for how to use their verified ID and/or associated data) directly and then share the intent, ID, and/or data with others via a consent mechanism. The consumer intent or consent mechanism may be provided and utilized by a portal, application, or other suitable method or component. In one embodiment, an intent may be associated with one or more of the following categories of consent with regards to distribution or use of a verified ID and associated data:
Preferences for shareable information for the PRSM—for session management, a consumer can opt-in to enable sharing of certain types of information to ensure a more seamless authentication process. This might include but is not limited to age verification, a verified identity flag, a reputation score, and/or other personalized attributes if available;
Consumer profile information—this could include information regarding consumer likes/dislikes, such as hobbies, interests, activities, or lifestyles, as non-limiting examples;
Immediate purchase intents—a consumer can provide information on their intent related to an immediate purchase. This information could include items, brand, or a time range of the expected purchase, as non-limiting examples. This information can be used by marketing and/or advertising agencies to deliver specific offers to the user and promote a purchase.

Once the consumer intent(s) are captured, they are linked to the DID via W3C standards or other suitable means or protocol.

FIG. 3(b) is a diagram illustrating elements, components, functions, operations, and processes for the capture of consumer intents or intentions and linking those intents to the DID, in accordance with an embodiment of the disclosure. See FIG. 1(b) for further information on the integration of intent services with other aspects of the disclosed architecture.

As a non-limiting example, an intent service could enable a consumer to identify profile information with respect to his/her likes/dislikes and/or an immediate purchase “intent” as described. This information can be tied to the DID using W3C protocols. The consumer can then make this data and information available to others via consent (per W3C protocols) using the IDaaS and/or PRSM. This provides a consumer with the ability to control information they wish to share, while providing relying parties (if the consumer consents) relevant information that enables them to personalize service and product offerings to a consumer. This can assist both a consumer and vendor in identifying a potential purchase or a desired service.

Embodiments of the disclosure are directed to a system and associated architecture or methodology that enables a user or consumer to remain anonymous, but able to verify their information, and if desired, provide verified identity data to a relying party. This is beneficial, as the rise of new environments such as gaming, augmented reality, virtual reality, and other Web 3.0 implementations make current approaches to identity verification and management insufficient to provide users with a desired level of security and convenience.

As discussed, the identity ecosystem has three major stakeholders (represented by consumers/users, relying parties, and authoritative sources). Thus far, conventional approaches have largely focused on addressing the needs of either the consumer or the relying party. As a result, these approaches have not addressed the needs across the entire identity ecosystem and have not been widely adopted. Identity security and management is a multiple stakeholder system and current approaches address only one or two of the stakeholders and thereby create a reluctance for the other party or parties to participate due to inefficiencies for those other stakeholders.

Furthermore, privacy has become a more significant concern due to increased regulatory regimes and heightened consumer awareness concerning protecting personally identifiable information (PII). In addition, consumer adoption in new environments is often predicated on anonymity, where consumers provide identity information only when required, and usually for a specific transaction or for purposes of compliance with a regulation. Because of this increased concern with privacy, new environments and uses would benefit from a more frictionless user experience and one that enables interoperability and transportability of a verified identity as consumers interact (transition) between one environment or use and another.

Aspects of the disclosed and/or described system and methods include (but are not limited to) the services used to associate data to a verifiable credential/DID. Another aspect is the use of the DID for session management. While session management is used in some conventional system architectures, it has not been implemented using the DID as the reference information pointer for session management workflow.

The combination of DIDs and session management enables users to quickly transition from one environment to another with the authentication for access being performed in the background, and without the need for additional user interaction. For example, assume a member of “SportsLeague” authenticates and gains access to SportLeague's website. The member can then seamlessly navigate to a member “Team” website where the Team can leverage the session management and attributes tied to the session management to enable access. Via the PRSM functionality, “Team” will be able to provide access using the session management information. Further, from the “Teams” website, a member may wish to purchase age-restricted goods. The “Team's” website can then obtain an age verified attribute from the PRSM that would be part of the initial authentication payload in the PRSM.

In general, there has been a lack of viewing the identity management requirements from a holistic point of view. For example, the stakeholders that are concerned with privacy are focused on a solution that will address the privacy problem, resulting in the blockchain/DID models or Identity Application models. However, they haven't considered the effort that enterprises will need to make to integrate a blockchain system into their existing technology, or the critical mass of consumer-oriented application adoption that would be needed to represent a practical solution. Conversely, people who are trying to implement more easily integrated systems are relying on 3rd parties, many of whom access central databases which are increasingly being scrutinized for privacy and security concerns.

In general, decentralized, distributed ledger systems (such as blockchain) offer benefits over a traditional centralized database system. As non-limiting examples, they offer consumer control, limit large scale identity data breaches, and enable federated identity approaches. Although these systems address consumer privacy concerns, conventional systems and approaches do not easily address relying party technical and business concerns.

In many cases, these conventional decentralized identity systems do not have an authoritative source ecosystem established or a critical mass of consumer adoption. In addition, integration with traditional IT system and architecture is not easy and usually requires a non-standard and/or impractical approach. Similarly, other methods such as Wallet Applications, Data Aggregators, and other cyber security solutions do not address the concerns of all the stake holders that make up the identity triad, i.e., consumers, relying parties, and authoritative sources.

In addition, to implement a truly anonymous identity system and associated ID requires creating a credential using multiple 3rd parties. For a relying party to have a credible claim of maintaining a consumer's anonymity would be difficult if they are integrating with those services directly. For example, if a relying party does an age check and scans a driver's license, they may claim that they are only capturing a birthdate, but there is no reliable way to verify this. As such, those companies rely on 3rd parties, who traditionally rely on central databases without the privacy and security benefits many users are seeking or demanding.

An aspect of the disclosed and/or described system and methods is the creation of an “application-less” experience. The ability to obtain the release or transfer of identity information as consented to by a consumer without an application poses a technical challenge that is addressed by one or more embodiments of this disclosure.

A DID holder typically enables access to information on (or associated with) the DID via private encryption keys that are stored, secured, and managed by an application on a device. The disclosed and/or described system and methods enable access to information on (or associated with) the DID in an efficient manner. In addition, the disclosed and/or described system and methods enable access to the DID within a cloud and/or remote environment, where access to the DID is provided by the DID holder using cloud based and/or client-server-based communication protocols for the encryption keys. In addition, the IDaaS and PRSM components of the disclosed and/or described system can be implemented as API and/or browser based. These aspects of the disclosed and/or described system lend themselves to a “application-less” environment.

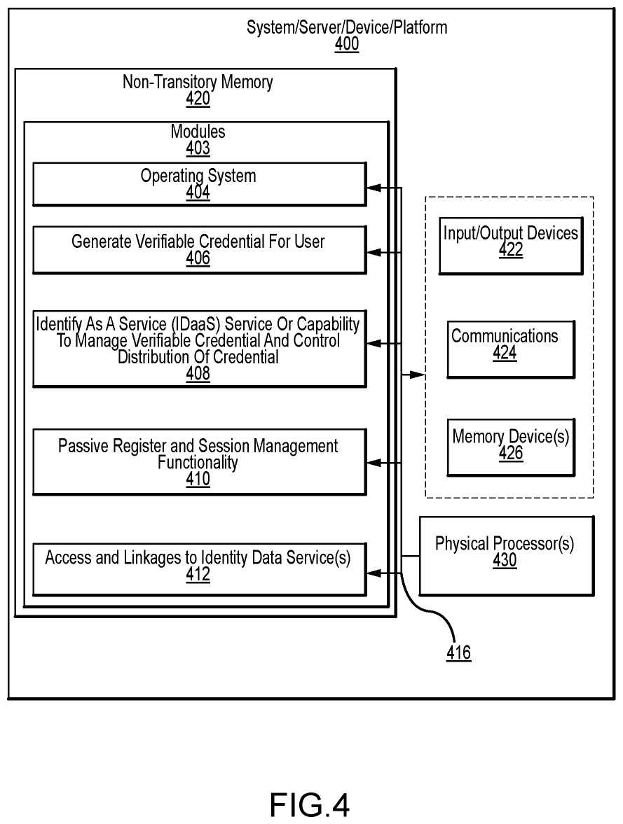

FIG. 4 is a diagram illustrating elements or components that may be present in a computing device, platform, or system configured to implement a method, process, function, or operation in accordance with an embodiment of the system and methods disclosed and/or described herein. As noted, in some embodiments, the system and methods may be implemented in the form of an apparatus (or device, system, or platform) that includes a processing element and set of executable instructions stored in (or on) a non-transitory computer-readable medium. The executable instructions may be part of a software application and arranged into a software architecture.

In general, an embodiment may be implemented using a set of software instructions that are designed to be executed by a suitably programmed processing element (such as a GPU, CPU, TPU, QPU, microprocessor, processor, co-processor, or controller, as non-limiting examples). In a complex application or system such instructions are typically arranged into “modules” with each such module typically performing a specific task, process, function, or operation when the instructions in it are executed. The entire set of modules may be controlled or coordinated in their operation by an operating system (OS) or other form of organizational platform.

A module or sub-module may correspond to a particular function, method, process, or operation that is implemented by execution of the instructions in the module or sub-module. Such function, method, process, or operation may include those used to implement one or more aspects of the disclosed and/or described systems, apparatuses, and methods.

The modules and/or sub-modules may include a suitable computer-executable code or set of instructions (such as would be executed by a suitably programmed processor, microprocessor, co-processor, or CPU, as examples), such as computer-executable code corresponding to a programming language. For example, programming language source code may be compiled into computer-executable code. Alternatively, or in addition, the programming language may be an interpreted programming language such as a scripting language.

The modules (or sub-modules) may contain one or more sets of instructions for performing a method, operation, or function described with reference to the Figures, and/or disclosed and/or described in the specification. These modules may include those illustrated but may also include a greater number or fewer number than those illustrated. As mentioned, each module or sub-module may contain a set of computer-executable instructions. The set of instructions may be executed by a programmed processor contained in a server, client device, network element, system, platform, or other component.

A module may contain instructions that are executed by a processor contained in more than one of a server, client device, network element, system, platform, or other component. Thus, in some embodiments, a plurality of electronic processors, with each being part of a separate device, server, or system may be responsible for executing all or a portion of the software instructions contained in an illustrated module. Although FIG. 4 illustrates a set of modules which taken together perform multiple functions or operations, these functions or operations may be performed by different devices or system elements, with certain of the modules (or instructions contained in those modules) being associated with those devices or system elements.

As shown in FIG. 4, system 400 may represent a server or other form of computing or data processing system, platform, or device. Modules 403 each contain a set of executable instructions, where when the set of instructions is executed by a suitable electronic processor or processors (such as that indicated in the figure by “Physical Processor(s) 430”), system (or server, platform, or device) 400 operates to perform a specific process, operation, function, or method. Modules 403 are stored in a non-transitory memory 420, which typically includes an Operating System module 404 that contains instructions used (among other functions) to access and control the execution of the instructions contained in other modules.

The modules 403 stored in memory 420 are accessed for purposes of transferring data and executing instructions by use of a “bus” or communications line 416, which also serves to permit processor(s) 430 to communicate with the modules for purposes of accessing and executing a set of instructions. Bus or communications line 416 also permits processor(s) 430 to interact with other elements of system 400, such as input or output devices 422, communications elements 424 for exchanging data and information with devices external to system 400, and additional memory devices 426.

For example, Modules 403 may contain computer-executable instructions which when executed by a programmed processor cause the processor or a device in which it is implemented (which may be a server, platform, or system, or a mobile or client device in which an application is installed) to perform the following set of processes, methods, functions, or operations:
Generate a Verifiable Credential for a User (as suggested by module 406);
Provide an Identity as a Service (IDaaS) Service or Capability to Manage the Verifiable Credential and Control Distribution of the Credential (module 408);
Enable a Passive Register and Session Management Functionality (module 410), as described with reference to FIG. 2(a), FIG. 2(b) and the references to the PRSM functionality; and
Provide Access and Linkages to one or more Identity Data Service(s) (module 412), as described with reference to FIG. 3(a), FIG. 3(b), and the other references herein.

As mentioned, in some embodiments, the systems and methods disclosed and/or described herein may provide services through a Software-as-a-Service (SaaS) or multi-tenant platform. The platform provides access to multiple entities, each with a separate account and associated data storage. Each account may correspond to a user (e.g., a consumer or relying party), set of users, an entity, a set or category of entities, a set or category of users, or an organization, for example. Each account may access one or more services, a set of which are instantiated in their account, and which implement one or more of the methods or functions disclosed and/or described herein.

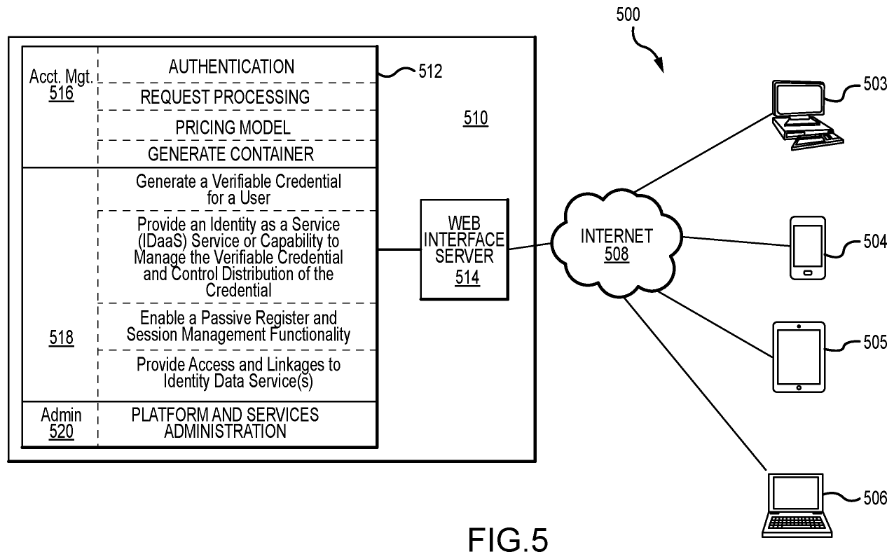

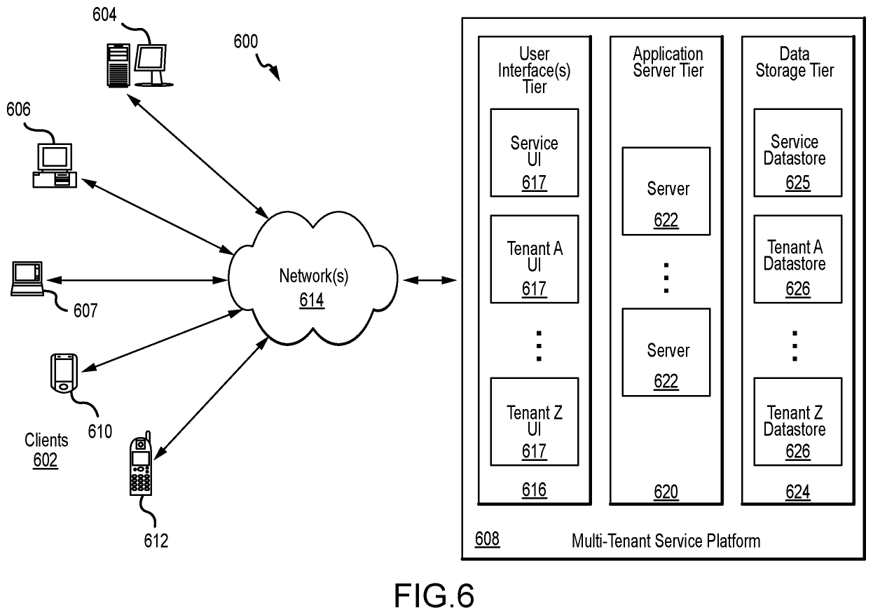

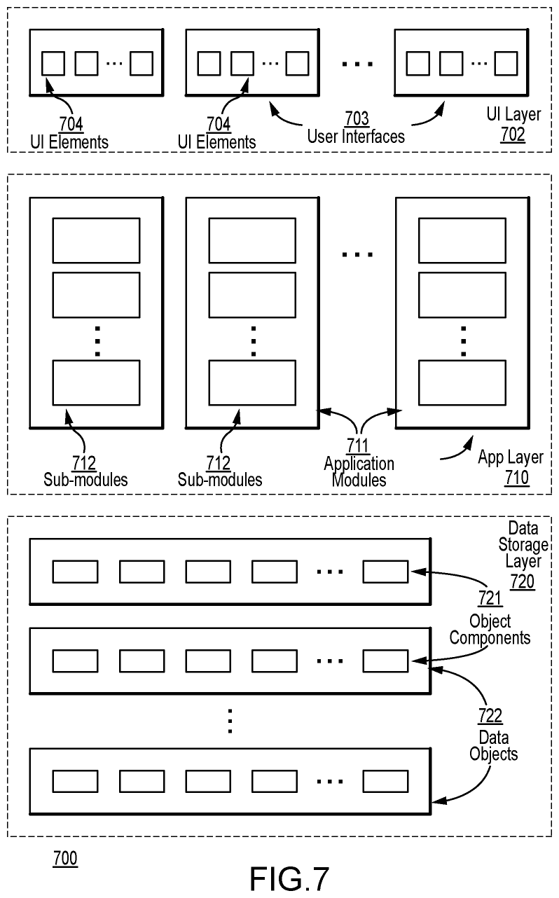

FIG. 5 is a diagram illustrating a SaaS system in which an embodiment of the disclosure may be implemented. FIG. 6 is a diagram illustrating elements or components of an example operating environment in which an embodiment of the disclosure may be implemented. FIG. 7 is a diagram illustrating additional details of the elements or components of the multi-tenant distributed computing service platform of FIG. 6, in which an embodiment of the disclosure may be implemented.

In some embodiments, the system or service(s) disclosed and/or described herein may be implemented as micro-services, processes, workflows, or functions performed in response to requests. The micro-services, processes, workflows, or functions may be performed by a server, data processing element, platform, or system. In some embodiments, the services may be provided by a service platform located “in the cloud”. In such embodiments, the platform is accessible through APIs and SDKs.

The disclosed and/or described identity verification and management services may be provided as micro-services within the platform for each of multiple users or entities. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 5-7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the identity verification and management processes disclosed and/or described herein.

Although in some embodiments, a platform or system of the type illustrated in FIGS. 5-7 may be operated by a 3^{rd} party provider, in other embodiments, the platform may be operated by a provider and a different source may provide the applications or services for users through the platform.

FIG. 5 is a diagram illustrating a system 500 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, stores, or organizations, as non-limiting examples.

A user may access the services using a suitable client, including but not limited to desktop computers, laptop computers, tablet computers, scanners, or smartphones. In general, a client device having access to the Internet may be used to initiate and access a service provided by the platform or system. Users interface with the service platform across the Internet 508 or another suitable communications network or combination of networks. Non-limiting examples of suitable client devices include desktop computers 503, smartphones 504, tablet computers 505, or laptop computers 506.

System 510, which may be hosted by a third party, may include a set of services 512 and a web interface server 514, coupled as shown in FIG. 5. Either or both services 512 and the web interface server 514 may be implemented on one or more different hardware systems and components, even though represented as singular units in FIG. 5. Services 512 may include one or more functions or operations for the processing of a party's or entity's request for identity issuance, identity verification, or identity management.

In some embodiments, the set of applications available to a company or user may include one or more that perform the functions and methods disclosed and/or described herein, example embodiments of which have been described with reference to the Figures. As discussed, these functions or processing workflows may be used to issue a verified credential, verify a credential, and/or manage the release or transfer of the credential.

As examples, in some embodiments, the set of applications, functions, operations or services made available through the platform or system 510 may include:
account management services 516, such as
   a process or service to authenticate a person or entity requesting a service (such as credentials or proof of purchase, verification that the customer has been authorized to use the services, etc.);
   a process or service to receive a request for a service involving a verified credential;
   an optional process or service to generate a price for the requested service or a charge against a service contract;
   a process or service to generate a container or instantiation of the requested processes for a user/customer, where the instantiation may be customized for a particular user, entity, or company; and
   other forms of account management services;
credential creation and utilization processes or services 518, such as
   Generating a Verifiable Credential for a User;
   Providing an Identity as a Service (IDaaS) Service or Capability to Manage the Verifiable Credential and Control Distribution of the Credential;
   Enabling a Passive Register and Session Management Functionality; and
   Providing Access and Linkages to Identity Data Service(s); and
administrative services 520, such as
   a process or services to enable the provider of the processing and services and/or the platform to administer and configure the processes and services provided to users.

The platform or system shown in FIG. 5 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

FIG. 6 is a diagram illustrating elements or components of an example operating environment 600 in which an embodiment of the disclosure may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., software) implemented at least in part by one or more of the computing devices.

Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components (such as one or more electronic processors, microprocessors, central processing units (CPU), or controllers). Examples of suitable networks 614 include networks utilizing wired and/or wireless communication technologies and networks operating in accordance with a suitable networking and/or communication protocol (e.g., the Internet).

The distributed computing service/platform (which may also be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations, as examples. Each application server or processing tier 622 shown in the figure may be implemented with a set of computers and/or components including computer servers and processors, and may perform various functions, methods, processes, or operations as determined by the execution of a software application or set of instructions. The data storage tier 624 may include one or more data stores, which may include a Service Data store 625 and one or more Tenant Data stores 626. Data stores may be implemented with any suitable data storage technology, including structured query language (SQL) based relational database management systems (RDBMS).

Service Platform 608 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 622 that are part of the platform's Application Server Tier 620. As noted with regards to FIG. 5, the platform system shown in FIG. 6 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the identity credential issuance, identity verification, or identity management services disclosed and/or described) are provided to users, with each company/business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 7 is a diagram illustrating additional details of the elements or components of the multi-tenant distributed computing service platform of FIG. 6, in which an embodiment of the disclosure may be implemented. The software architecture shown in FIG. 7 represents an example of an architecture which may be used to implement an embodiment. In general, an embodiment may be implemented using a set of software instructions that are designed to be executed by a suitably programmed processing element (such as a CPU, microprocessor, GPU, processor, controller, or other form of computing device). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, in which an embodiment of the disclosure may be implemented. The example architecture includes a user interface layer or tier 702 having one or more user interfaces 703. Examples of such user interfaces include graphical user interfaces and application programming interfaces (APIs). Each user interface may include one or more interface elements 704. Users may interact with interface elements to access functionality and/or data provided by application and/or data storage layers of the example architecture.

Examples of suitable graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing data processing and services to a user of the platform). Such function, method, process, or operation may include those used to implement one or more aspects of the disclosed and/or described system and methods, such as for one or more of the processes, operations, or functions disclosed and/or described with reference to the Figures and specification:
Generating a Verifiable Credential for a User;
Providing an Identity as a Service (IDaaS) Service or Capability to Manage the Verifiable Credential and Control Distribution of the Credential;
Enabling a Passive Register and Session Management Functionality; and
Providing Access and Linkages to Identity Data Service(s).

The application modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 5-7 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

Embodiments of the disclosure can be implemented in the form of control logic using computer software in a modular or integrated manner. Based on the disclosure and teachings provided herein, a person of ordinary skill in the art will know and appreciate other ways and/or methods to implement one or more embodiments using hardware and a combination of hardware and software.

In some embodiments, certain of the methods, models or functions disclosed herein may be embodied in the form of a trained neural network or broader machine learning algorithm, where the algorithm is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform, self-hosted software or on-premise software, or a service provided through such a platform.

A trained neural network, trained machine learning model, or other form of decision or classification process may be used to implement one or more of the methods, functions, processes, or operations disclosed herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labelled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Machine learning (ML) is being used to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or example, in the form of one or more parameters, variables, characteristics or “features”) of the set of training data is associated with a label or annotation that defines how the element should be classified by the trained model. A machine learning model is an algorithm that can predict outcomes based on data and training provided to it to make a decision (such as a classification) regarding a sample of input data. When trained, the model will operate on a new element of input data to generate the correct label or classification as an output.

The disclosure includes the following clauses and embodiments:

1. A system for creating and managing credentials, comprising:
one or more non-transitory computer-readable media including a set of computer-executable instructions; and
one or more electronic processors configured to execute the set of computer-executable instructions, wherein when executed, the instructions cause the one or more electronic processors or a device or apparatus in which they are contained to
   generate a verifiable credential for a user;
   manage the verifiable credential and control distribution of the verifiable credential to another party upon receiving approval from the user;
   provide a passive register and session management functionality for use with the verified credential, the passive register providing storage for one or more of identity verification, attribute verification, or other authentication data or metadata; and
   enable one or more identity data services to be linked to the verifiable credential, the identity data services comprising services that generate or provide additional information about the user.

2. The system of clause 1, wherein the verifiable credential is generated in accordance with W3C protocols for a decentralized identifier (DID).

3. The system of clause 1, wherein the one or more identity data services comprise transaction data services, reputation score services, user intent data services, and a relying party system.

4. The system of clause 1, wherein the verifiable credential includes identity information about the user and one or more user attributes.

5. The system of clause 4, wherein the one or more user attributes include a license or a verified fact about the user.

6. The system of clause 5, wherein the verified fact is one of the user's age, the user being older than a specific age, the user's educational status, or the user's socio-economic status.

7. A method of enabling a user to be authenticated by a website or service, comprising:
creating a globally unique identifier for a user;
receiving a request from a website or service to verify an item of information or data regarding the user;
receiving a request from the user to provide the item of data or information to the website or service;
providing the globally unique identifier for the user and the item of data or information to a passive register; and enabling the website or service to access the passive register and the globally unique identifier for the user and the item of data or information.

8. The method of clause 7, wherein the globally unique identifier is generated in accordance with W3C protocols for a decentralized identifier (DID).

9. The method of clause 7, wherein the globally unique identifier includes identity information about the user and one or more user attributes.

10. The method of clause 9, wherein the one or more user attributes include a license or a verified fact about the user.

11. The method of clause 10, wherein the verified fact is one of the user's age, the user being older than a specific age, the user's educational status, or the user's socio-economic status.

12. The method of clause 7, further comprising enabling one or more identity data services to be linked to the globally unique identifier, the identity data services comprising services that generate or provide additional information about the user.

13. The method of clause 12, wherein the one or more identity data services comprise transaction data services, reputation score services, user intent data services, and a relying party system.

14. One or more non-transitory computer-readable media including a set of computer-executable instructions that when executed by one or more programmed electronic processors, cause the processors or a device or apparatus in which they are contained to
generate a verifiable credential for a user;
manage the verifiable credential and control distribution of the verifiable credential to another party upon receiving approval from the user;
provide a passive register and session management functionality for use with the verified credential, the passive register providing storage for one or more of identity verification, attribute verification, or other authentication data or metadata; and
enable one or more identity data services to be linked to the verifiable credential, the identity data services comprising services that generate or provide additional information about the user.

15. The one or more non-transitory computer-readable media of clause 14, wherein the verifiable credential is generated in accordance with W3C protocols for a decentralized identifier (DID).

16. The one or more non-transitory computer-readable media of clause 14, wherein the one or more identity data services comprise transaction data services, reputation score services, user intent data services, and a relying party system.

17. The one or more non-transitory computer-readable media of clause 14, wherein the verifiable credential includes identity information about the user and one or more user attributes.

18. The one or more non-transitory computer-readable media of clause 17, wherein the one or more user attributes include a license or a verified fact about the user.

19. The one or more non-transitory computer-readable media of clause 18, wherein the verified fact is one of the user's age, the user being older than a specific age, the user's educational status, or the user's socio-economic status.

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies.

Such computer-readable storage media allow the processing element or processor to access computer-executable process steps, application programs and the like, stored on removable and non-removable memory media, to off-load data from a device or to upload data to a device. As mentioned, with regards to the embodiments disclosed and/or described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted.

Recitation of ranges of values herein are merely indented to serve as a shorthand method of referring individually to each separate value inclusively falling within the range, unless otherwise indicated herein, and each separate value is incorporated into the specification as if it were individually recited herein. Methods described herein may be performed in a suitable order unless otherwise indicated herein or clearly contradicted by context. The use of examples, or exemplary language (e.g., “such as”) provided herein, is intended to better illuminate embodiments of the disclosure, and does not pose a limitation to the scope of the invention unless otherwise claimed. No language in the specification should be construed as indicating a non-claimed element as essential to each embodiment of the disclosure.

As used herein (i.e., the claims, figures, and specification), the term “or” is used inclusively to refer items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not for restrictive purposes, and alternative embodiments will become apparent to readers of this specification. Accordingly, the present disclosure is not limited to the embodiments described or depicted in the drawings, and various embodiments and modifications may be made without departing from the scope of the claims below.

That which is claimed is:

1. A system for creating and managing credentials, comprising:
one or more non-transitory computer-readable media including a set of computer-executable instructions; and
one or more electronic processors configured to execute the set of computer-executable instructions, wherein when executed, the instructions cause the one or more electronic processors or a device or apparatus in which they are contained to
generate a verifiable credential for a user;
manage the verifiable credential and control distribution of the verifiable credential to another party upon receiving approval from the user;
provide a passive register and session management functionality for use with the verified credential, the passive register providing storage for one or more of identity verification, attribute verification, or other authentication data or metadata; and
enable one or more identity data services to be linked to the verifiable credential, the identity data services comprising services that generate or provide additional information about the user.

2. The system of claim 1, wherein the verifiable credential is generated in accordance with W3C protocols for a decentralized identifier (DID).

3. The system of claim 1, wherein the one or more identity data services comprise transaction data services, reputation score services, user intent data services, and a relying party system.

4. The system of claim 1, wherein the verifiable credential includes identity information about the user and one or more user attributes.

5. The system of claim 4, wherein the one or more user attributes include a license or a verified fact about the user.

6. The system of claim 5, wherein the verified fact is one of the user's age, the user being older than a specific age, the user's educational status, or the user's socio-economic status.

7. A method of enabling a user to be authenticated by a website or service, comprising:
creating a globally unique identifier for a user;
receiving a request from a website or service to verify an item of information or data regarding the user;
receiving a request from the user to provide the item of data or information to the website or service;
providing the globally unique identifier for the user and the item of data or information to a passive register; and
enabling the website or service to access the passive register and the globally unique identifier for the user and the item of data or information.

8. The method of claim 7, wherein the globally unique identifier is generated in accordance with W3C protocols for a decentralized identifier (DID).

9. The method of claim 7, wherein the globally unique identifier includes identity information about the user and one or more user attributes.

10. The method of claim 9, wherein the one or more user attributes include a license or a verified fact about the user.

11. The method of claim 10, wherein the verified fact is one of the user's age, the user being older than a specific age, the user's educational status, or the user's socio-economic status.

12. The method of claim 7, further comprising enabling one or more identity data services to be linked to the globally unique identifier, the identity data services comprising services that generate or provide additional information about the user.

13. The method of claim 12, wherein the one or more identity data services comprise transaction data services, reputation score services, user intent data services, and a relying party system.

14. One or more non-transitory computer-readable media including a set of computer-executable instructions that when executed by one or more programmed electronic processors, cause the processors or a device or apparatus in which they are contained to
generate a verifiable credential for a user;
manage the verifiable credential and control distribution of the verifiable credential to another party upon receiving approval from the user;
provide a passive register and session management functionality for use with the verified credential, the passive register providing storage for one or more of identity verification, attribute verification, or other authentication data or metadata; and
enable one or more identity data services to be linked to the verifiable credential, the identity data services comprising services that generate or provide additional information about the user.

15. The one or more non-transitory computer-readable media of claim 14, wherein the verifiable credential is generated in accordance with W3C protocols for a decentralized identifier (DID).

16. The one or more non-transitory computer-readable media of claim 14, wherein the one or more identity data services comprise transaction data services, reputation score services, user intent data services, and a relying party system.

17. The one or more non-transitory computer-readable media of claim 14, wherein the verifiable credential includes identity information about the user and one or more user attributes.

18. The one or more non-transitory computer-readable media of claim 17, wherein the one or more user attributes include a license or a verified fact about the user.

19. The one or more non-transitory computer-readable media of claim 18, wherein the verified fact is one of the user's age, the user being older than a specific age, the user's educational status, or the user's socio-economic status.
